(19) United States
(12) Patent Application Publication
(10) Pub. No.: US 2018/0259958 A1
(43) Pub. Date: Sep. 13, 2018

(54) PERSONALIZED CONTENT CREATION FOR AUTONOMOUS VEHICLE RIDES

(71) Applicant: Uber Technologies, Inc., San Francisco, CA (US)

(72) Inventors: Travis Kalanick, San Francisco, CA (US); Matthew Sweeney, Pittsburgh, PA (US); Logan Rockmore, Pittsburgh, PA (US); Emily Bartel, Pittsburgh, PA (US)

(21) Appl. No.: 15/454,941

(22) Filed: Mar. 9, 2017

(51) Int. Cl. G05D 1/00; G05D 1/02

(52) U.S. Cl. CPC G05D 1/0088; G05D 1/0212; G05D 1/0236

(57) ABSTRACT

An on-board user interface device of an autonomous vehicle (AV) can detect a transition of the AV from a manual drive mode to an autonomous drive mode. In response to detecting the transition, the user interface device can receive live sensor data from a control system of the AV, where the live sensor data can indicate a surrounding environment of the AV. In autonomous drive mode, the user interface device can receive an input on a camera input mechanism to activate a camera. In response to the input on the camera input mechanism, the user interface device can capture an image of a passenger of the AV, and compile a plurality of frames of the live sensor data.

### BACKGROUND

Through use of ever more sophisticated and robust computer perception, object classification, and prediction techniques, autonomous vehicle (AV) technology is rapidly evolving towards Level 5 autonomy in which no human intervention is required in the driving operations of the AV. However, while the technology may be rapidly progressing, AV ubiquity on public roads and highways will require significant manufacturing scaling, cost reductions, and public acceptance, and is on the order of several years to a decade or more in the future. Accordingly, passengers desiring on-demand transport will generally encounter only human drivers operating non-autonomous or partially autonomous vehicles in which the human driver maintains awareness and control of the vehicle over the course of the trip. On occasion, a passenger requesting on-demand transport will be picked up by a Level 4 or Level 5 AV (e.g., an AV that includes a trained safety driver or no driver at all), which will remain a novel experience while AV ubiquity is gradually achieved.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example autonomous vehicle operated by a control system and implementing an on-board user interface device, as described herein;

FIG. 2 is a block diagram illustrating an example on-board user interface device utilized in connection with a control system of an autonomous vehicle, according to examples described herein;

FIG. 3 is a flow chart describing a method of generating user content for a passenger of an autonomous vehicle, according to examples described herein;

FIG. 4 is a flow chart describing a lower level method of generating user content for a passenger of an autonomous vehicle, according to examples described herein;

FIG. 5 is a block diagram illustrating a computer system for an autonomous vehicle upon which examples described herein may be implemented; and

FIG. 6 is a block diagram illustrating a computer system for a backend datacenter upon which example transport systems described herein may be implemented.

### DETAILED DESCRIPTION

An on-board computing device is disclosed herein and can include a communication interface to connect with a control system of an autonomous vehicle (AV). The computing device can include a camera and can detect, from the AV's computer system, a transition of the AV from a manual drive mode to an autonomous drive mode. In response to detecting the transition, the on-board computing device can receive live sensor data from the control system of the AV via the communication interface. The live sensor data can indicate a surrounding environment of the AV, and can comprise at least one of LIDAR data or image data. The computing device may then receive an input on a camera input mechanism to activate the camera. In response to the input on the camera input mechanism, the computing device can (i) capture an image of a passenger of the AV, and (ii) compile a plurality of frames of the live sensor data.

In various examples, the on-board computing device can transmit, over a network, the captured image of the passenger and the plurality of frames of the live sensor data to a remote computing system to enable the creation of personalized passenger content, such as a layered image or graphics interchange format (GIF) content for the passenger. In variations, the on-board computing device can independently generate the personalized content using the captured image and sensor data frames. Upon creating the personalized content, the remote computing system or the on-board computing device can upload the content to a sharing resource (e.g., a social media platform), and provide the passenger with a link to the content. For example, the computing device can display the link for the passenger or otherwise transmit the link to the passenger's personal computing device (e.g., the passenger's smartphone) via a designated application (e.g., a rider application enabling access to an on-demand transportation service of which the AV comprises a service provider).

In certain implementations, the remote computing system can connect with the passenger's personal computing device via the designated rider application to preclude a direct connection between the passenger's device and the on-board computing device of the AV (e.g., for purposes of network security of the AV), and can provide the passenger with the personalized content, or access to the personalized content. Thereafter, the passenger may locally store the content, or can share the content with one or more contacts or groups with which the passenger is associated.

Creation of the personalized content by the remote computing system or the on-board computing device can comprise persistently overlaying the captured image of the passenger with each of the plurality of frames of the live sensor data to create personalized GIF content of the passenger riding in the AV. The GIF content can comprise live sensor data frames (e.g., LIDAR data frames corresponding to an overhead sensor view of the AV) that are correlated to the timing of the captured image. For example, the passenger's input to activate the camera can trigger the on-board computing device to retrieve a current set of sensor data frames (e.g., either a immediately previous set, an immediate future set, or a combination of both).

In certain aspects, the on-board computing device can be positioned in a manner such that the rear seats of the AV can be included in a field of the view of the camera. Additionally, the on-board computing device can include a display screen facing the rear seats to enable the passenger to preview the captured image prior to providing the triggering input. The on-board computing device can comprise an installed tablet computer, or can comprise components dispersed throughout the AV. For example, the display and camera can be installed on the rear surface of a front seat, or on a rearward facing panel between the front seats, while the computational requirements can be executed by the on-board data processing system of the AV. In various examples, the on-board computing device can access, either wirelessly or via a data bus, the live sensor data from the AV's sensor suite or control system to compile the sensor data set correlated with the captured image of the passenger.

As used herein, a computing device refers to devices corresponding to desktop computers, cellular devices or smartphones, personal digital assistants (PDAs), laptop computers, tablet devices, virtual reality (VR) and/or augmented reality (AR) devices, wearable computing devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, virtual reality (VR) or augmented reality (AR) computers, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as those carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

As provided herein, the term “autonomous vehicle” (AV) describes any vehicle operating in a state of autonomous control with respect to acceleration, steering, braking, auxiliary controls (e.g., lights and directional signaling), and the like. Different levels of autonomy may exist with respect to AVs. For example, some vehicles may enable autonomous control in limited scenarios, such as on highways. More advanced AVs, such as those described herein, can operate in a variety of traffic environments without any human assistance. Accordingly, an “AV control system” can process sensor data from the AV's sensor array, and modulate acceleration, steering, and braking inputs to safely drive the AV along a given route.

Autonomous Vehicle Description

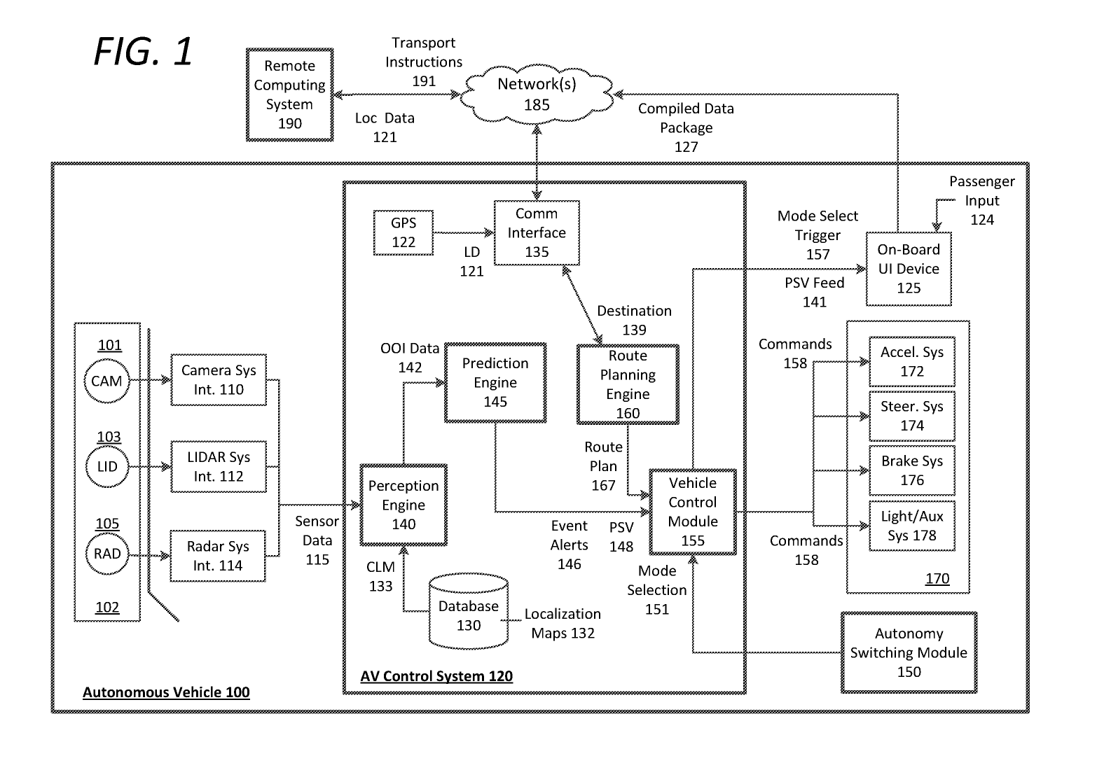

FIG. 1 is a block diagram illustrating an example autonomous vehicle (AV) operated by a control system and implementing an on-board user interface device, as described herein. In an example of FIG. 1, a control system 120 can autonomously operate the AV 100 in a given geographic region to provide on-demand transportation services for requesting riders. In examples described, the AV 100 can operate without human control or with limited safety driver controller. For example, the AV 100 can autonomously steer, accelerate, shift, brake, and operate lighting components. Some variations also recognize that the AV 100 can switch between an autonomous mode, in which the AV control system 120 autonomously operates the AV 100, and a manual mode in which a driver takes over manual control of the acceleration system 172, steering system 174, braking system 176, and lighting and auxiliary systems 178 (e.g., directional signals and headlights). For example, the AV 100 can include an autonomy switching module 150 that the driver can activate and deactivate to switch the AV 100 between the manual mode and the autonomy mode.

According to some examples, the control system 120 can utilize specific sensor resources in order to autonomously operate the AV 100 in a variety of driving environments and conditions. For example, the control system 120 can operate the AV 100 by autonomously operating the steering, acceleration, and braking systems 172, 174, 176 of the AV 100 to a specified destination 139. The control system 120 can perform vehicle control actions (e.g., braking, steering, accelerating) and route planning using sensor information, as well as other inputs (e.g., transmissions from remote or local human operators, network communication from other vehicles, etc.).

In an example of FIG. 1, the control system 120 includes computational resources (e.g., processing cores and/or field programmable gate arrays (FPGAs)) which operate to process sensor data 115 received from a sensor system 102 of the AV 100 that provides a sensor view of a road segment upon which the AV 100 operates. The sensor data 115 can be used to determine actions which are to be performed by the AV 100 in order for the AV 100 to continue on a route to the destination 139, or in accordance with a set of transport instructions 191 received from a remote computing system 190 that manages routing for a fleet of AVs operating throughout a given region. In some variations, the control system 120 can include other functionality, such as wireless communication capabilities using a communication interface 135, to send and/or receive wireless communications over one or more networks 185 with one or more remote sources, including the remote computing system 190. In controlling the AV 100, the control system 120 can generate commands 158 to control the various control mechanisms 170 of the AV 100, including the vehicle's acceleration system 172, steering system 157, braking system 176, and auxiliary systems 178 (e.g., lights and directional signals).

The AV 100 can be equipped with multiple types of sensors 102 which can combine to provide a computerized perception, or sensor view, of the space and the physical environment surrounding the AV 100. Likewise, the control system 120 can operate within the AV 100 to receive sensor data 115 from the sensor suite 102 and to control the various control mechanisms 170 in order to autonomously operate the AV 100. For example, the control system 120 can analyze the sensor data 115 to generate low level commands 158 executable by the acceleration system 172, steering system 157, and braking system 176 of the AV 100. Execution of the commands 158 by the control mechanisms 170 can result in throttle inputs, braking inputs, and steering inputs that collectively cause the AV 100 to operate along sequential road segments according to a route plan 167.

In more detail, the sensor suite 102 operates to collectively obtain a live sensor view for the AV 100 (e.g., in a forward operational direction, or providing a 360 degree sensor view), and to further obtain situational information proximate to the AV 100, including any potential hazards or obstacles. By way of example, the sensors 102 can include multiple sets of camera systems 101 (video cameras, stereoscopic cameras or depth perception cameras, long range monocular cameras), LIDAR systems 103, one or more radar systems 105, and various other sensor resources such as sonar, proximity sensors, infrared sensors, and the like. According to examples provided herein, the sensors 102 can be arranged or grouped in a sensor system or array (e.g., in a sensor pod mounted to the roof of the AV 100) comprising any number of LIDAR, radar, monocular camera, stereoscopic camera, sonar, infrared, or other active or passive sensor systems.

Each of the sensors 102 can communicate with the control system 120 utilizing a corresponding sensor interface 110, 112, 114. Each of the sensor interfaces 110, 112, 114 can include, for example, hardware and/or other logical components which are coupled or otherwise provided with the respective sensor. For example, the sensors 102 can include a video camera and/or stereoscopic camera system 101 which continually generates image data of the physical environment of the AV 100. The camera system 101 can provide the image data for the control system 120 via a camera system interface 110. Likewise, the LIDAR system 103 can provide LIDAR data to the control system 120 via a LIDAR system interface 112. Furthermore, as provided herein, radar data from the radar system 105 of the AV 100 can be provided to the control system 120 via a radar system interface 114. In some examples, the sensor interfaces 110, 112, 114 can include dedicated processing resources, such as provided with field programmable gate arrays (FPGAs) which can, for example, receive and/or preprocess raw image data from the camera sensor.

In general, the sensor systems 102 collectively provide sensor data 115 to a perception engine 140 of the control system 120. The perception engine 140 can access a database 130 comprising stored localization maps 132 of the given region in which the AV 100 operates. As provided herein, the localization maps 132 can comprise highly detailed ground truth data of each road segment of the given region. For example, the localization maps 132 can comprise prerecorded data (e.g., sensor data including image data, LIDAR data, and the like) by specialized mapping vehicles or other AVs with recording sensors and equipment, and can be processed to pinpoint various objects of interest (e.g., traffic signals, road signs, and other static objects). As the AV 100 travels along a given route, the perception engine 140 can access a current localization map 133 of a current road segment to compare the details of the current localization map 133 with the sensor data 115 in order to detect and classify any objects of interest, such as moving vehicles, pedestrians, bicyclists, and the like.

In various examples, the perception engine 140 can dynamically compare the live sensor data 115 from the AV's sensor systems 102 to the current localization map 133 as the AV 100 travels through a corresponding road segment. The perception engine 140 can flag or otherwise identify any objects of interest in the live sensor data 115 that can indicate a potential hazard. In accordance with many examples, the perception engine 140 can provide object of interest data 142 to a prediction engine 145 of the control system 120, wherein the objects of interest in the object of interest data 142 indicates each classified object that can comprise a potential hazard (e.g., a pedestrian, bicyclist, unknown objects, other vehicles, etc.).

Based on the classification of the objects in the object of interest data 142, the prediction engine 145 can predict a path of each object of interest and determine whether the AV control system 120 should respond or react accordingly. For example, the prediction engine 140 can dynamically calculate a collision probability for each object of interest, and generate event alerts 151 if the collision probability exceeds a certain threshold. As described herein, such event alerts 151 can be processed by the vehicle control module 155, along with a processed sensor view 148 indicating the classified objects within the live sensor view of the AV 100. The vehicle control module 155 can then generate control commands 158 executable by the various control mechanisms 170 of the AV 100, such as the AV's acceleration, steering, and braking systems 172, 174, 176.

On a higher level, the AV control system 120 can include a route planning engine 160 that provides the vehicle control module 155 with a route plan 167 to a given destination 139, such as a pick-up location, a drop off location, or an exit point within an autonomy grid map. In various aspects, the route planning engine 160 can generate the route plan 167 based on transport instructions 191 received from the hybrid trip planning system 190 over one or more networks 185. According to examples described herein, the AV 100 can include a location-based resource, such as a GPS module 122, that provides location data 121 (e.g., periodic location pings) to the remote computing system 190. Based on the AV's 100 location data 121, the remote computing system 190 may select the AV 100 to service a particular transport request by transmitting transport instructions 191 to the AV 100. The transport instructions 191 can include, among other things, the destination 139 (e.g., a pick-up location and drop-off location), requester identifying information, an optimal route to the destination 139, and the like. In variations, the destination 139 can be provided by the passenger via voice inputs or a passenger input 124 on an on-board user interface device 125 of the AV 100.

In various examples, when the AV 100 is selected to service transport request from a rider, the hybrid planning system 190 can transmit the transport instructions 191 to the communication interface to 135 over the one or more networks 185. As described herein, transport instructions 191 can provide the route planning engine 160 with an overall route at least from given pickup location to a drop off location for requesting user. In some aspects, the transport instructions 191 can also provide route data from the AV's 100 current location to the pickup location and/or from the drop-off location to a next pick-up location. As provided herein, the utilization of the AV 100 for on-demand transportation can comprise the remote computing system 190 providing the AV 100 with successive transport instructions 191 or destinations 139, which can enable the route planning engine 160 to generate corresponding route plans 167 utilized by the vehicle control module 155.

It is contemplated that a safety driver of the AV 100 can selectively transition the AV 100 from manual drive mode to autonomy drive mode using the autonomy switching module 150. In certain aspects, the AV 100 may only operate in autonomy mode when the AV 100 enters a mapped autonomy grid in which localization maps 132 have been recorded and labeled. Thus, when the AV 100 exits the autonomy grid, the safety driver can input a mode selection 151 on the autonomy switching module 150 to transition the AV 100 back to manual drive mode. Along these lines, when the driver enters the autonomy grid, the driver can provide a mode selection input 151 on the autonomy switching module 150 to transition the AV 100 back to autonomy drive mode.

The mode selection 151 can be processed by the vehicle control module 155 to either take over or hand off control of the AV's control mechanisms 170. According to examples described herein, when the AV 100 is in manual drive mode, the on-board user interface device 125 can display live mapping data indicating the AV's 100 progress towards the destination 139 on a live map. When the mode selection 151 indicates a transition to autonomy mode, the vehicle control module 155 can analyze the processed sensor view 148 in order to generate control commands 158 to autonomously drive the AV 100 according to the current route plan 167. In addition, the mode selection 151 can trigger the on-board user interface device 125 to display a live view of sensor data (e.g., displaying LIDAR data). For example, when the driver inputs a mode selection 151 on the autonomy switching module 150 to transition the AV 100 into the autonomy drive mode, the vehicle control module 155 can transmit a mode selection trigger 157 to the on-board user interface device 125 to cause the user interface device 125 to receive a processed sensor view feed 141 from one or more of the AV's sensor systems 102 (e.g., the LIDAR sensors 103). The user interface device 125 may then display the live sensor view of the AV 100 operating autonomously towards the destination 139.

As provided herein, the on-board user interface device 125 can comprise a display screen, processing resources, an input mechanism (e.g., touch sensors on the display screen or an analog button), a camera, and a data bus (e.g., wireless or wired) providing the user interface device 125 with access to the sensor view feed 141 for display. In one example, the on-board user interface device 125 can comprise a tablet computer, such as an IPAD manufactured by APPLE INC. In other examples, the components of the user interface device 125 may be distributed spatially throughout the AV 100. For example, the user interface device 125 can utilize the processing resources of the AV 100 (e.g., a computer stack executing the perception engine 140, the prediction engine 145, and vehicle control module 155), and can connect with one or more cameras having a field of view that includes one or more of the passenger seats.

According to various examples, when the AV 100 is in autonomy drive mode, the on-board user interface device 125 can enable image capture functionality such that the passenger can provide a passenger input 124 on the user interface device 125 to activate its camera and capture a photograph or video of the passenger within the AV 100. In addition to triggering the camera to capture the photo or video of the passenger, the passenger input 124 can also trigger the user interface device 125 to compile or store one or more sensor data frames from the processed sensor view feed 141 (e.g., ˜thirty frames) in order to generate a compiled data package 127 comprising the captured image or video of the passenger and the compiled sensor data frames.

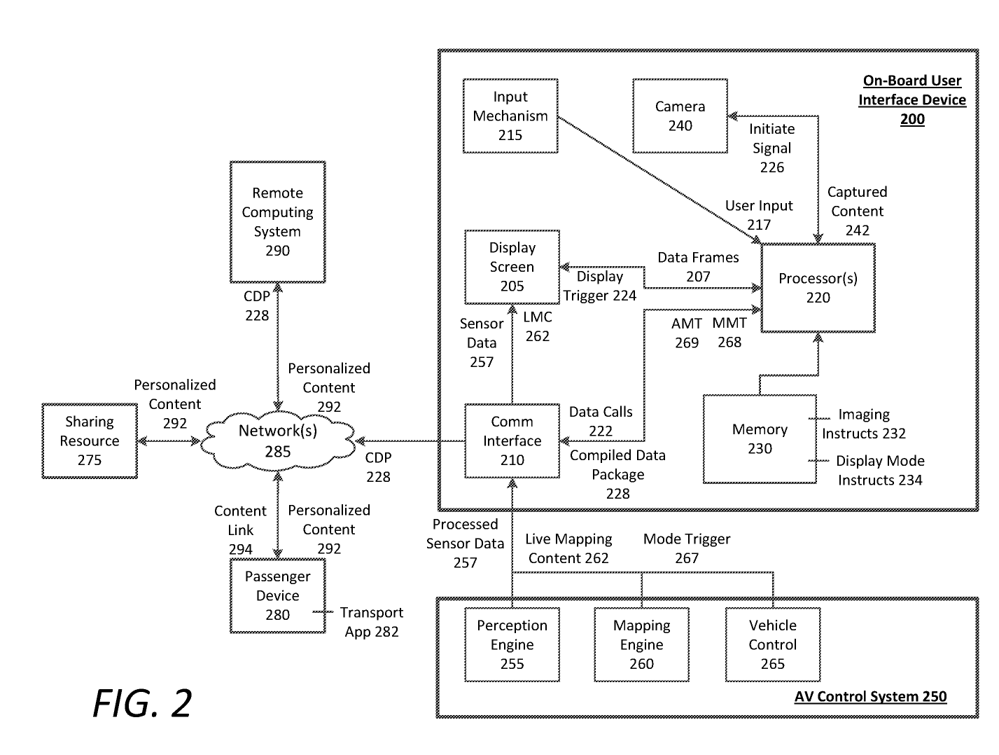

In some aspects, the on-board user interface device 125 may then transmit the compiled data package 127 to the remote computing system 190 over the one or more networks 185. The remote computing system 190 may then generate personalized user experience content (e.g., a layered image or GIF file) from the compiled data package 127, and provide the content to the passenger (e.g., via an executing rider application on the passenger's mobile computing device). In variations, the on-board user interface device 125 can generate the personalized user experience content from the compiled data package 127 and can provide the content to the passenger. Further description of the on-board user interface device 125 is provided below with respect to FIG. 2.

On-Board User Interface

FIG. 2 is a block diagram illustrating an example on-board user interface device utilized in connection with a control system of an autonomous vehicle, according to examples described herein. The on-board user interface device 200 of FIG. 2 can be included with an AV, and can correspond to the user interface device 125 shown and described in connection with FIG. 1. In various examples, the on-board user interface device 200 can include a communication interface 210 that enables the user interface device 200 to communicate wirelessly over one or more networks 285 and/or via a wired data bus with the AV's control system 250. The AV control system 250 of FIG. 2 can correspond to the AV control system 120 shown and described with respect to FIG. 1, and thus can include at least the perception engine 255, the mapping engine 260, and the vehicle control module 265. In various implementations, the on-board user interface device 200 can access or otherwise receive data from the AV control system 250 in response to certain triggering conditions on the AV, as described herein.

The on-board user interface device 200 can further include memory 230 storing imaging instructions 232 and display mode instructions 234, and can further include one or more processors 220 that can selectively execute the instructions 232, 234 in response to mode triggers 267 from the vehicle control module 265 and user inputs 217 from an input mechanism 215 of the user interface device 200. As provided herein, the display mode instructions 234 can cause the processors 220 to respond to mode triggers 267 from the AV control system 250, whereas the imaging instructions 232 can cause the processors 220 to operate that camera 240 and compile processed sensor data 257 as described herein. In various examples, a mode trigger 267 from the vehicle control module 265 can indicate that the AV is in manual drive mode. This manual mode trigger 268 can be received by the processor(s) 220, which can, in response, generate a data call 222 to access live mapping content 262 from the mapping engine 260. The processors 220 can then generate a display trigger 224 to cause the live mapping content 262 to be displayed on the display screen 205 of the user interface device 200. The live mapping content 262 and can show the AV's progress towards the destination on a live map.

According to examples, the processors 220 can receive an autonomy mode trigger 269 from the vehicle control module 265 indicating that the driver has transitioned the AV into autonomy drive mode. In response to the autonomy mode trigger 269, the processors 220 can transmit a data call 222 to the perception engine 255 to access or otherwise receive the processed sensor data 257 (e.g., LIDAR data). The processors 220 may then transmit a display trigger 224 to the display screen 205 to cause the display screen 205 to display the processed sensor data 257 accordingly. As provided herein, the displayed sensor data 257 can comprise processed LIDAR data by the perception engine 255 and can indicate classified objects, such as other vehicles, pedestrians, bicyclists, etc. In variations, the displayed sensor data 257 can comprise raw LIDAR data from one or more LIDAR sensors of the AV.

Also in response to the autonomy mode trigger 269, the processors 220 can generate an initiate signal 226 to initiate the camera 240 and enable the passenger to selectively activate the camera 240. Thus, when the autonomy drive mode is initiated, the on-board user interface device 200 can display the processed sensor data 257 and enable passengers to take photographs or videos of themselves while riding in the AV as the AV operates in autonomy drive mode. The displayed sensor data 257 can indicate the live sensor view from the AV's sensor systems that the AV control system 250 processes in order to autonomously operate the AV's control mechanisms.

While in autonomy drive mode, the passenger can provide a user input 217 on the input mechanism 215 to activate the camera 240. In some aspects, the user input 217 can cause the processors 220 to generate a display trigger 225 causing the display screen 205 to display the field of view of the camera 240 to enable the passenger to self-position in order to be captured in the resultant captured content 242 by the camera 240. In various implementations, the user input 217 can trigger the camera 240 to record an image or video of the passenger within the AV, and can also trigger the processors 220 to retrieve data frames 207 from the processed sensor data 257. Accordingly, in executing the imaging instructions 232, the processors 220 can compile the captured content 242 of the passenger from the camera 240 and the data frames 207 from the perception engine 255. In some examples, the processors 220 may then transmit the compiled data package 228 to a remote resource over the one or more networks 285.

In one example, the processors 220 of the on-board user interface device 200 can generate the personalized content 292 for the passenger from the compiled data package 228, and then transmit the personalized content 292 to the passenger's computing device 280. In variations, the on-board user interface device 200 can outsource the personalized content 292 generation to a remote computing system 290. In such variations, the remote computing system 290 can receive the compiled data package 228 from the on-board user interface device 200, generate the personalized content 292, and can either transmit the personalized content 292 to a sharing resource 275 or to the passenger's computing device 280. In some aspects, the remote computing system 290 can provide the passenger's computing device 280 with a content link 294 to the personalized content 292 at the sharing resource 275 to enable the passenger to share the personalized content 292 with the passenger's acquaintances, friends, and/or contacts.

As provided herein, the personalized content 292 can comprise a layered image, video, or GIF content that includes the captured content 242 of the passenger overlaying the data frames 207 of the sensor data 257. For example, the captured content 242 can comprise an image of the passenger, and the data frames 207 can comprise LIDAR data images from the AV's sensor suite. The resultant personalized content 292 can then comprise the image of the passenger layered atop each of the LIDAR data images, and can be compiled as GIF content with the passenger's image persistently overlaying the GIF content. In certain variations, the passenger can preview the personalized content 292 on the display screen 205, and can be provided with the option of adding filters (e.g., colorized filters) or editing the content 292 prior to the content 292 being uploaded to the sharing resource 275.

In various implementations, the sharing resource 275 can comprise a social media platform, such as FACEBOOK, SNAPCHAT, or TWITTER. In further implementations, the remote computing system 290 can communicate with the passenger's computing device 280 via an executing transport application 282 executing thereon. For example, the passenger can launch the transport application 282 to make on-demand transportation requests, which the remote computing system 290 can process to match the passenger with the AV. Thus, the AV 100 of FIG. 1 can be instructed by the remote computing system 290 to service the passenger's pick-up request sent via the transport application 282. While on-trip, the passenger may then utilize the on-board user interface device 200 as described herein.

Methodology

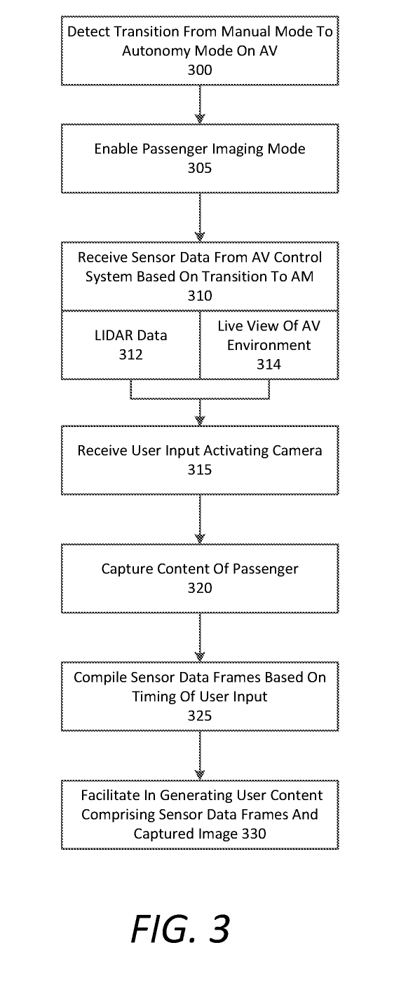

FIG. 3 is a flow chart describing a method of generating user content for a passenger of an autonomous vehicle, according to examples described herein. In the below description of FIG. 3, reference may be made to reference characters representing like features as shown and described with respect to FIGS. 1 and 2. Furthermore, the below processes described in connection with FIG. 3 may be performed by an example on-board user interface device, such as the on-board user interface devices 125, 200 described with respect to FIGS. 1 and 2. Referring to FIG. 3, the user interface device 200 can detect a transition of the AV 100 from manual mode to autonomy mode (300). In response to the detected transition to autonomy mode, the user interface device 200 can enable a passenger imaging mode to facilitate in creating personalized rider experience content for the passenger (305).

Furthermore, based on the autonomy mode transition, the user interface device 200 can access or otherwise receive sensor data 257 from the AV's control system 250 (310). As described herein, the sensor data 257 can comprise processed LIDAR data (312) and can show a live LIDAR view of the AV's environment as the AV 100 operates autonomously towards the destination 139 (314). While the user interface device 200 is in passenger imaging mode, the user interface device 200 can receive a user input 217 activating the camera 240 (315). In response to the user input 217, the user interface device 200 can capture content 242 including the passenger, such as an image or video (320). In further response to the user input 217, the user interface device 200 can compile sensor data frames 207 from the live sensor data feed 257 based on the timing of the user input 217 (325). For example, the user interface device 200 can retrieve the previous or future thirty or so data frames 207 of the LIDAR sensor view. Thereafter, the user interface device 200 can facilitate in generating the personalized user content 292 comprising the sensor data frames 207 and the captured content 242 of the passenger (330). In doing so, the user interface device 200 can transmit the compiled data 228 to a remote computing system 290 to generate the personalized content 292, or can generate the content 292 independently. Thereafter, the remote computing system 290 or the user interface device 200 can provide access to the personalized content 292 to the passenger for storage or sharing.

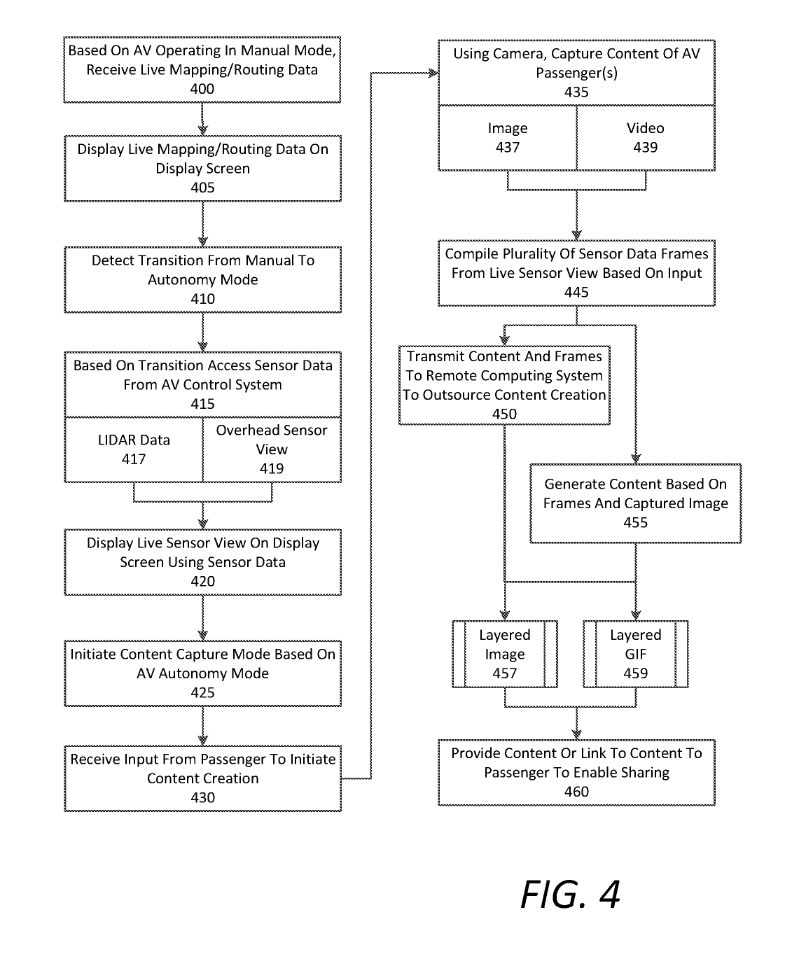

FIG. 4 is a flow chart describing a lower level method of generating user content for a passenger of an autonomous vehicle, according to examples described herein. As in the description of FIG. 3, reference may also be made to reference characters representing like features as shown as described with respect to FIGS. 1 and 2. Referring to FIG. 4, the user interface device 200 can receive live mapping and/or routing data 262 from the AV control system 250 based on the AV being in manual mode (400). When the AV 100 is in manual drive mode, the user interface device 200 can display the live mapping and/or routing data 262 on the display screen 205 (405). This displayed mapping/routing content 262 can show a representation of the AV 100 traveling along a current route on a live virtual map.

According to examples described herein, the user interface device 200 can detect a transition of the AV 100 from manual mode to autonomy mode (410). Based on the transition, the user interface device 200 can access processed sensor data 257 from the AV control system 250 (415). In various examples, the sensor data 257 can comprise LIDAR data (417) and can provide an overhead sensor view of the AV 100 autonomously driving along a current route within the LIDAR data (419). The user interface device 200 may then display the live sensor view 257 on the display screen 205 (420), and initiate a content or image capture mode based on the AV 100 being in autonomy mode (425).

The user interface device 200 may then receive a user input 217 from a passenger of the AV 100 to initiate content creation (430). In response to the user input 217, the user interface device can capture content 242 of the AV's passenger(s) (435). As described herein, the captured content 242 can comprise and image (437) or video (439). Furthermore, in response to the user input 217, the user interface device 200 can also compile a plurality of sensor data frames 207 from the live sensor view 257 (445). Thereafter, the user interface device 200 can either transmit the captured content 242 and data frames 207 to a remote computing system 290 to outsource the personalized content 292 creation (450), or can generate the personalized content 292 locally based on the captured image 242 and data frames 207 (455). As described herein, the personalized content 292 can comprise a layered image having the captured image 242 of the passenger overlaying an image of the sensor data 257 (457), or can comprise layered GIF content having the captured image 242 of the passenger persistently overlaying the plurality of sensor data frames 207 (459). The user interface device 200 or remote computing system 290 may then provide the passenger with the personalized content 292 or a link 294 to the personalized content 292 to enable sharing by the passenger (460).

Hardware Diagrams

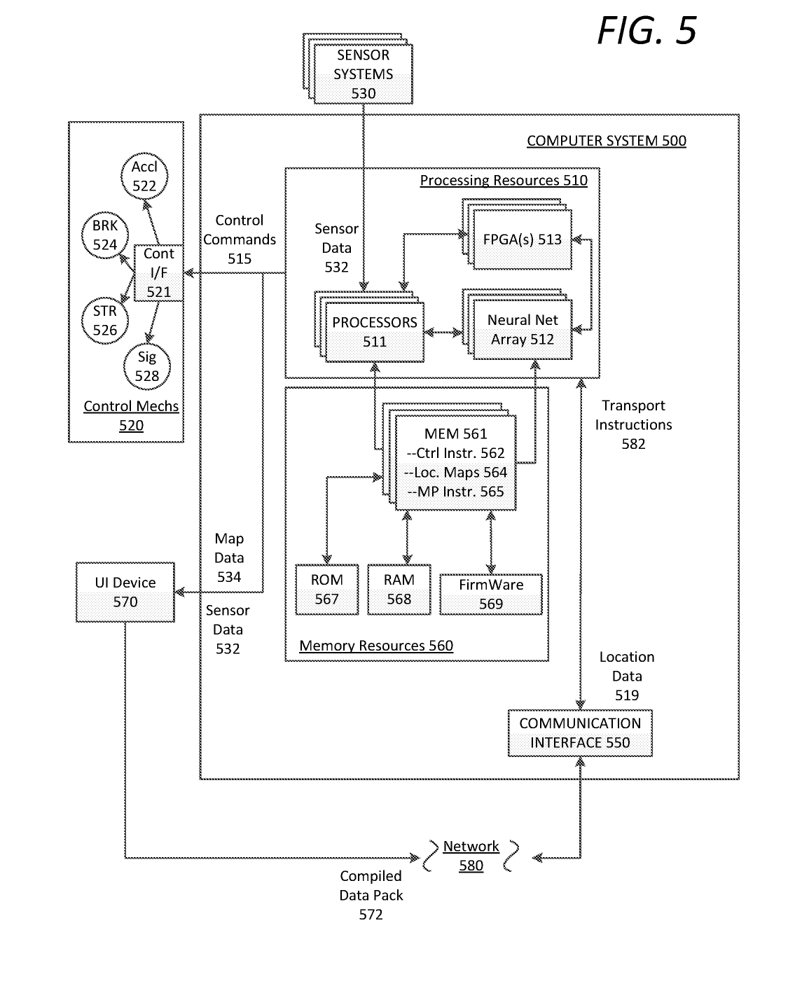

FIG. 5 is a block diagram illustrating a computer system upon which example AV processing systems described herein may be implemented. The computer system 500 can be implemented using a number of processing resources 510, which can comprise processors 511 and/or field programmable gate arrays (FPGAs) 513. In some aspects, any number of processors 511 and/or FPGAs 513 of the computer system 500 can be utilized as components of a neural network array 512 implementing a machine learning model and utilizing road network maps stored in memory 561 of the computer system 500. In the context of FIGS. 1 and 2, various aspects and components of the AV control system 120, 250 can be implemented using one or more components of the computer system 500 shown in FIG. 5.

According to some examples, the computer system 500 may be implemented within an autonomous vehicle (AV) with software and hardware resources such as described with examples of FIGS. 1 and 2. In an example shown, the computer system 500 can be distributed spatially into various regions of the AV, with various aspects integrated with other components of the AV itself. For example, the processing resources 510 and/or memory resources 560 can be provided in a cargo space of the AV. The various processing resources 510 of the computer system 500 can also execute control instructions 562 using microprocessors 511, FPGAs 513, a neural network array 512, or any combination of the same.

In an example of FIG. 5, the computer system 500 can include a communication interface 550 that can enable communications over a network 580. In one implementation, the communication interface 550 can also provide a data bus or other local links to electro-mechanical interfaces of the vehicle, such as wireless or wired links to and from control mechanisms 520 (e.g., via a control interface 521), sensor systems 530, and can further provide a network link to a remote computing system or backend transport management system (implemented on one or more datacenters) over one or more networks 580. For example, the computer system 500 can communicate with the remote computing system over the network 580 to transmit periodic location data 519 and receive transport instructions 582 to pick-up and drop off respective passengers.

The memory resources 560 can include, for example, main memory 561, a read-only memory (ROM) 567, storage device, and cache resources. The main memory 561 of memory resources 560 can include random access memory (RAM) 568 or other dynamic storage device, for storing information and instructions which are executable by the processing resources 510 of the computer system 500. The processing resources 510 can execute instructions for processing information stored with the main memory 561 of the memory resources 560. The main memory 561 can also store temporary variables or other intermediate information which can be used during execution of instructions by the processing resources 510. The memory resources 560 can also include ROM 567 or other static storage device for storing static information and instructions for the processing resources 510. The memory resources 560 can also include other forms of memory devices and components, such as a magnetic disk or optical disk, for purpose of storing information and instructions for use by the processing resources 510. The computer system 500 can further be implemented using any combination of volatile and/or non-volatile memory, such as flash memory, PROM, EPROM, EEPROM (e.g., storing firmware 569), DRAM, cache resources, hard disk drives, and/or solid state drives.

The memory 561 may also store localization maps 564 in which the processing resources 510—executing the control instructions 562—continuously compare to sensor data 532 from the various sensor systems 530 of the AV.

Execution of the control instructions 562 can cause the processing resources 510 to generate control commands 515 in order to autonomously operate the AV's acceleration 522, braking 524, steering 526, and signaling systems 528 (collectively, the control mechanisms 520). On a lower level, the memory 561 can store motion planning instructions 565 executable by the processing resources 510 to simultaneously generate a hierarchical set of motion plans, as described herein. Thus, in executing the control instructions 562 and motion planning instructions 565, the processing resources 510 can receive sensor data 532 from the sensor systems 530, dynamically compare the sensor data 532 to a current localization map 564, and generate control commands 515 for operative control over the acceleration, steering, and braking of the AV along a particular motion plan. The processing resources 510 may then transmit the control commands 515 to one or more control interfaces 522 of the control mechanisms 520 to autonomously operate the AV through road traffic on roads and highways, as described throughout the present disclosure.

In various examples, the processing resources 510 of the computer system 500 can connect with a user interface device 570, such as the user interface device 125, 200 discussed with respect to FIGS. 1 and 2, and throughout the present disclosure. The user interface device 570 can receive map data 534 and sensor data 532 depending on whether the AV operates in manual drive mode or autonomous drive mode, as described herein. The user interface device 570 can also provide a compiled data package 572 comprising captured content of the passenger as well as sensor data frames from the sensor data 532 in order to facilitate in creating personalized passenger content for the passenger.

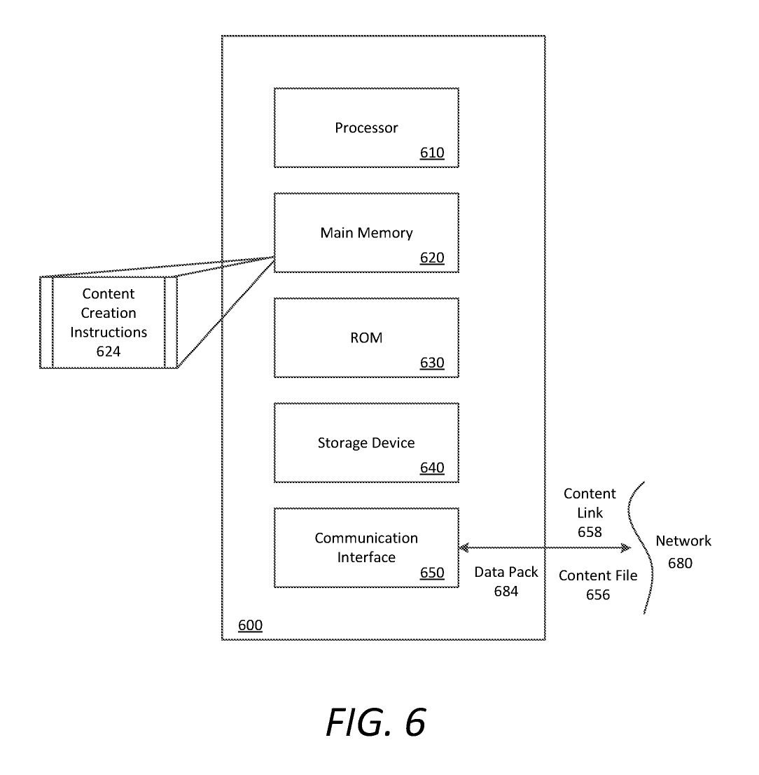

FIG. 6 is a block diagram that illustrates a computer system upon which examples described herein may be implemented. A computer system 600 can be implemented on, for example, a server or combination of servers. For example, the computer system 600 may be implemented as part of a network service for providing transportation services. In the context of FIGS. 1 and 2, the remote computing system 190, 290 may be implemented using a computer system 600 such as described by FIG. 6.

In one implementation, the computer system 600 includes processing resources 610, a main memory 620, a read-only memory (ROM) 630, a storage device 640, and a communication interface 650. The computer system 600 includes at least one processor 610 for processing information stored in the main memory 620, such as provided by a random access memory (RAM) or other dynamic storage device, for storing information and instructions which are executable by the processor 610. The main memory 620 also may be used for storing temporary variables or other intermediate information during execution of instructions to be executed by the processor 610. The computer system 600 may also include the ROM 630 or other static storage device for storing static information and instructions for the processor 610. A storage device 640, such as a magnetic disk or optical disk, is provided for storing information and instructions.

The communication interface 650 enables the computer system 600 to communicate over one or more networks 680 (e.g., cellular network) through use of the network link (wireless or wired). Using the network link, the computer system 600 can communicate with one or more mobile computing devices (e.g., via an executing transport application), one or more servers, and/or one or more autonomous vehicles. The executable instructions stored in the memory 620 can include content creation instructions 624, which enables the computer system 600 to receive compiled data packages 684 from user interface devices of AVs described herein. Execution of the content creation instructions 624 can cause the processor 610 to generate a personalized content file 656 for an AV passenger, and transmit the content file 656 or a content link 658 to the file 656 to a computing device of the passenger.

The processor 610 is configured with software and/or other logic to perform one or more processes, steps and other functions described with implementations, such as described with respect to FIGS. 1-4, and elsewhere in the present application. Examples described herein are related to the use of the computer system 600 for implementing the techniques described herein. According to one example, those techniques are performed by the computer system 600 in response to the processor 610 executing one or more sequences of one or more instructions contained in the main memory 620. Such instructions may be read into the main memory 620 from another machine-readable medium, such as the storage device 640. Execution of the sequences of instructions contained in the main memory 620 causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature. Thus, the absence of describing combinations should not preclude claiming rights to such combinations.

1. An on-board computing device comprising:
a communication interface to connect with a control system of an autonomous vehicle (AV);
a camera;
one or more processors; and
a memory storing instructions that, when executed by the one or more processors, cause the one or more processors to:
detect a transition of the AV from a manual drive mode to an autonomous drive mode;
in response to detecting the transition, receive live sensor data from the control system of the AV via the communication interface, the live sensor data indicating a surrounding environment of the AV;
receive an input, from a passenger of the AV, on a camera input mechanism to activate the camera; and
in response to receiving the input on the camera input mechanism, (i) capture an image of the passenger of the AV, and (ii) compile a plurality of frames of the live sensor data.

2. The on-board computing device of claim 1, wherein the executed instructions further cause the one or more processors to:
transmit, over a network, the captured image of the passenger and the plurality of frames of the live sensor data to a remote computing system to enable the creation of a graphics interchange format (GIF) content for the passenger.

3. The on-board computing device of claim 2, wherein the GIF content comprises the captured image of the passenger persistently overlaid on each of the plurality of frames of the live sensor data.

4. The on-board computing device of claim 2, wherein the remote computing system provides access to the GIF content to a mobile computing device of the passenger to enable the passenger to upload the GIF content to a social media sharing platform.

5. The on-board computing device of claim 1, wherein the plurality of frames of the live sensor data correlate to a timing characteristic of the captured image.

6. The on-board computing device of claim 1, wherein the communication interface comprises a wired connection to the control system of the AV.

7. The on-board computing device of claim 1, wherein the plurality of frames of the live sensor data comprises LIDAR data frames of the surrounding environment of the AV.

8. The on-board computing device of claim 1, wherein the executed instructions further cause the one or more processors to:
generate graphics interchange format (GIF) content comprising the captured image of the passenger overlaid with each of the plurality of frame of the live sensor data.

9. The on-board computing device of claim 8, wherein the executed instructions further cause the one or more processors to:
transmit the GIF content to a mobile computing device of the passenger over a network.

10. The on-board computing device of claim 8, wherein the executed instructions further cause the one or more processors to:
upload the GIF content to a network resource; and
transmit a link to the GIF content to a mobile computing device of the passenger.

11. The on-board computing device of claim 1, further comprising:
a display screen;
wherein the executed instructions further cause the one or more processors to:
when the AV is in manual drive mode, generate map data on the display screen indicating a live map view of the AV traveling along a current route; and
when the AV is in autonomous drive mode, generate a live sensor view on the display screen, the live sensor view providing a video stream of the AV traveling along the current route in the live sensor data from the senor system of the AV.

12. A non-transitory computer readable medium storing instructions that, when executed by one or more processors of an on-board computing device of an autonomous vehicle (AV), cause the one or more processors to:
detect a transition of the AV from a manual drive mode to an autonomous drive mode;
in response to detecting the transition, receive live sensor data from a control system of the AV, the live sensor data indicating a surrounding environment of the AV;
receive an input, from a passenger of the AV, on a camera input mechanism to activate the camera; and
in response to receiving the input on the camera input mechanism, (i) capture an image of the passenger of the AV, and (ii) compile a plurality of frames of the live sensor data.

13. The non-transitory computer readable medium of claim 12, wherein the executed instructions further cause the one or more processors to:
transmit, over a network, the captured image of the passenger and the plurality of frames of the live sensor data to a remote computing system to enable the creation of graphics interchange format (GIF) content for the passenger.

14. The non-transitory computer readable medium of claim 13, wherein the GIF content comprises the captured image of the passenger persistently overlaid on each of the plurality of frames of the live sensor data.

15. The non-transitory computer readable medium of claim 13, wherein the remote computing system provides access to the GIF content to a mobile computing device of the passenger to enable the passenger to upload the GIF content to a social media sharing platform.

16. The non-transitory computer readable medium of claim 12, wherein the executed instructions further cause the one or more processors to:
generate a graphics interchange format (GIF) content comprising the captured image of the passenger overlaid with each of the plurality of frame of the live sensor data.

17. The non-transitory computer readable medium of claim 16, wherein the executed instructions further cause the one or more processors to:
transmit the GIF content to a mobile computing device of the passenger over a network.

18. The non-transitory computer readable medium of claim 16, wherein the executed instructions further cause the one or more processors to:
upload the GIF content to a network resource; and
transmit a link to the GIF content to a mobile computing device of the passenger over a network.

19. The non-transitory computer readable medium of claim 12, wherein the computing device comprises a display screen; and
wherein the executed instructions further cause the one or more processors to:
when the AV is in manual drive mode, generate map data on the display screen indicating a live map view of the AV traveling along a current route; and
when the AV is in autonomous drive mode, generate a live sensor view on the display screen, the live sensor view providing a video stream of the AV traveling along the current route in the live sensor data from the senor system of the AV.

20. A computer-implemented method of facilitating content creation, the method being performed by one or more processors and comprising:
detecting a transition of an autonomous vehicle (AVI from a manual drive mode to an autonomous drive mode;
in response to detecting the transition, receiving live sensor data from a control system of the AV, the live sensor data indicating a surrounding environment of the AV;
receiving an input, from a passenger of the AV, on a camera input mechanism to activate the camera; and
in response to receiving the input on the camera input mechanism, (i) capturing an image of the passenger of the AV, and (ii) compiling a plurality of frames of the live sensor data.
